(19) United States
(12) Patent Application Publication
(10) Pub. No.: US 2023/0054227 A1
(43) Pub. Date: Feb. 23, 2023

(54) AUTHENTICATION DEVICE, WIRELESS COMMUNICATION DEVICE, WIRELESS COMMUNICATION SYSTEM, METHOD, AND STORAGE MEDIUM

(71) Applicant: KABUSHIKI KAISHA TOSHIBA, Tokyo (JP)

(72) Inventors: Tatsuma HIRANO, Kawasaki Kanagawa (JP); Miyuki OGURA, Tachikawa Tokyo (JP); Toshihisa NABETANI, Kawasaki Kanagawa (JP)

(73) Assignee: KABUSHIKI KAISHA TOSHIBA, Tokyo (JP)

(21) Appl. No.: 17/679,869

(22) Filed: Feb. 24, 2022

(30) Foreign Application Priority Data
Aug. 23, 2021 (JP) 2021-135457

(51) Int. Cl. H04W 12/069

(52) U.S. Cl. CPC H04W 12/069

(57) ABSTRACT

According to one embodiment, an authentication device includes a memory and a processor. The memory stores a private key used for wireless communication executed by using each of network slices. The processor transmits a first random number for updating a first private key used for the wireless communication executed by using a first network slice and use start timing information regarding use start timing of the updated first private key to the wireless communication device by using a second network slice. The first private key updated based on the first random number is stored in the memory, and used for the wireless communication between a base station and the wireless communication device based on the use start timing.

### CROSS-REFERENCE TO RELATED APPLICATIONS

This application is based upon and claims the benefit of priority from Japanese Patent Application No. 2021-135457, filed Aug. 23, 2021, the entire contents of which are incorporated herein by reference.

### FIELD

Embodiments described herein relate generally to an authentication device, a wireless communication device, a wireless communication system, a method, and a storage medium.

### BACKGROUND

In recent years, a fifth generation (5G) mobile communication system has been studied in Third Generation Partnership Project (3GPP).

The 5G mobile communication system is based on the premise that various things are connected via a network, and in the 5G mobile communication system, wireless communication that realizes high speed, multiple connection, low latency, and the like can be performed. By using the 5G mobile communication system, it is expected to provide a wide range of services.

By the way, in the 5G mobile communication system, wireless communication can be performed in units called network slices, and it is necessary to appropriately operate the network slices.

### BRIEF DESCRIPTION OF THE DRAWINGS

FIG. 1 is a diagram illustrating an example of a configuration of a wireless communication system according to a first embodiment.

FIG. 2 is a diagram for describing authentication processing.

FIG. 3 is a block diagram illustrating an example of a configuration of an authentication device.

FIG. 4 is a block diagram illustrating an example of a configuration of a wireless terminal.

FIG. 5 is a diagram illustrating an example of a data structure of an information holding unit.

FIG. 6 is a flowchart illustrating an example of a processing procedure of an authentication device when a private key is updated.

FIG. 7 is a diagram for describing a specific example of processing of updating a private key.

FIG. 8 is a flowchart illustrating an example of a processing procedure of an authentication device when a private key is updated according to a second embodiment.

FIG. 9 is a flowchart illustrating an example of a processing procedure of an authentication device when a private key is updated according to a third embodiment.

### DETAILED DESCRIPTION

In general, according to one embodiment, an authentication device includes a memory and a processor. The memory is configured to store, for each of a plurality of network slices, a private key used for wireless communication executed by using each of the network slices constructed between a wireless communication device and the authentication device. The processor is configured to transmit a first random number for updating a first private key used for the wireless communication executed by using a first network slice included in the network slices and use start timing information regarding use start timing of the updated first private key to the wireless communication device by using a second network slice different from the first network slice. The first private key updated based on the first random number is stored in the memory, and used for the wireless communication between a base station and the wireless communication device based on the use start timing, the wireless communication being executed by using the first network slice.

Hereinafter, embodiments of the present invention will be described with reference to the drawings.

(First Embodiment)

First, the first embodiment will be described. FIG. 1 is a diagram illustrating an example of a configuration of a wireless communication system according to the present embodiment. The wireless communication system is, for example, a 5G mobile communication system, and includes an authentication device 10, a base station 20, and a wireless terminal 30.

The authentication device 10 executes processing of authenticating the wireless terminal 30 included in the wireless communication system (hereinafter, referred to as authentication processing).

The base station 20 is disposed between the authentication device 10 and the wireless terminal 30, and performs wireless communication with the wireless terminal 30 existing within a range covered by the base station 20. The authentication device 10 and the base station 20 are connected, for example, by wire.

The wireless terminal 30 is, for example, a terminal device (wireless communication device) that executes wireless communication with the base station 20 via a network when using a service provided in the wireless communication system (5G mobile communication system).

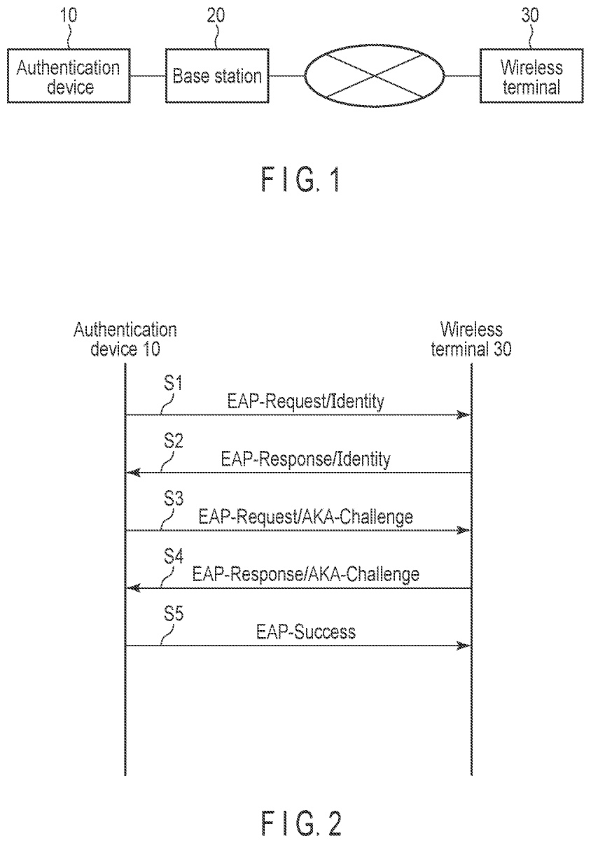

Here, with reference to FIG. 2, the authentication processing executed by the authentication device 10 described above will be briefly described. In the present embodiment, for example, it is described that authentication processing to which Extensible Authentication Protocol (EAP)-Authentication and Key Agreement (AKA) is applied will be described. Here, it is described that the authentication device 10 and the wireless terminal 30 execute communication processing, but the communication processing is executed via the base station 20 disposed between the authentication device 10 and the wireless terminal 30 as described above. The same applies to the following description.

First, the authentication device 10 transmits an EAP request (EAP-Request/Identity) to the wireless terminal 30 (Step S1).

When the processing in Step S1 is executed, the wireless terminal 30 transmits an EAP response (EAP-Response/Identity) to the authentication device 10 as a response to the EAP request transmitted in Step S1 (Step S2).

Next, the authentication device 10 transmits, to the wireless terminal 30, the EAP request (EAP-Request/AKA-Challenge) to which a random number (128 bit RAND) generated in the authentication device 10 and an authentication code (AUTN) for tamper prevention are added (Step S3).

Here, a SIM card is inserted into the wireless terminal 30, and a shared private key is written in the SIM card. The wireless terminal 30 calculates a cipher key (CK) and an integrity key (IK) from the shared private key written in the SIM card and the random number added to the EAP request transmitted from the authentication device 10 in Step S3, thereby generating a private key (private key based on CK and IK) used for wireless communication with the base station 20.

When the private key is generated as described above, the wireless terminal 30 calculates a response value XRES based on the shared private key and random number described above, and transmits the calculated response value XRES to the authentication device 10 as an EAP response (EAP-Response/AKA-Challenge) to the EAP request transmitted in Step S3 (Step S4).

The authentication device 10 compares the response value XRES transmitted in Step S4 with XRES calculated in advance based on the shared private key (shared private key identical to the shared private key written in the SIM card described above) held in a communication carrier and the random number transmitted to the wireless terminal 30 in Step S3 described above, and transmits a response (EAP-Success) indicating success of the authentication processing to the wireless terminal 30 in a case where the transmitted response value XRES matches with the XRES calculated in advance (Step S5).

In a case where the authentication processing described above is executed, the wireless terminal 30 executes wireless communication with the base station 20 by using the private key described above. Specifically, in a case where data is transmitted from the base station 20 to the wireless terminal 30 after the authentication processing is executed, the data is encrypted on the base station 20 side by using a public key paired with the private key described above in a public key cryptosystem, and is decrypted on the wireless terminal 30 side by using the private key.

Although not described here, the private key described above is also generated on the authentication device 10 side based on the shared private key held in the communication carrier and the random number transmitted to the wireless terminal 30. According to this, in a case where data is transmitted from the wireless terminal 30 to the base station 20, the data is encrypted on the wireless terminal 30 side by using the public key, and is decrypted on the base station 20 side by using the private key generated by the authentication device 10.

By executing the wireless communication described above between the base station 20 and the wireless terminal 30, safety of the wireless communication in the wireless communication system can be improved.

By the way, in the wireless communication system such as the 5G mobile communication system, it is necessary to cope with a wide range of requests for high speed, multiple connection, and low latency, and there is a technology (hereinafter, referred to as a network slicing technology) in which resources are logically divided into units called network slices and managed or operated according to characteristics of the various requests (requests and communication services).

According to this network slicing technology, a plurality of network slices (logical units) are constructed on a common hardware resource (server, a router, or the like) disposed in a network, and each of the network slices can be operated independently. By individually allocating each of the network slices to each service provided in the wireless communication system (5G mobile communication system), it is possible to avoid complexity of the network and configure an efficient network. In the network slicing technology, since the common hardware resource is virtually divided and allocated to each of the network slices, the utilization efficiency of the entire resource can be improved.

In a case where the network slices described above are constructed between the authentication device 10 (base station 20) and the wireless terminal 30, the authentication processing described above is executed for each of the network slices, and the private key for each of the network slices is generated in the authentication device 10 and the wireless terminal 30.

Hereinafter, configurations of the authentication device 10 and the wireless terminal 30 included in the wireless communication system according to the present embodiment will be described.

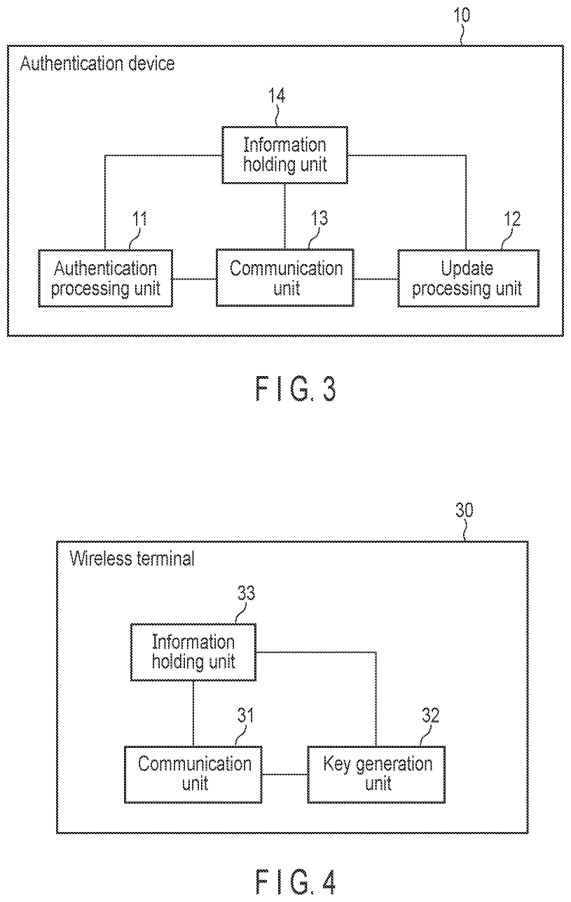

FIG. 3 is a block diagram illustrating an example of the configuration of the authentication device 10. As illustrated in FIG. 3, the authentication device 10 includes an authentication processing unit 11, an update processing unit 12, a communication unit 13, and an information holding unit 14.

The authentication processing unit 11 executes the authentication processing described above. The authentication processing unit 11 includes a random number generation unit (not illustrated) that generates a random number when the authentication processing described above is executed, and a key generation unit (not illustrated) that generates a private key used by the base station 20 when the wireless communication with the wireless terminal 30 is executed.

Here, the security of the wireless communication executed between the base station 20 and the wireless terminal 30 can be improved by using the private key described above, but in order to maintain the security, it is necessary to periodically update the private key.

The update processing unit 12 executes processing of updating the private key (hereinafter, referred to as update processing) generated in the authentication device 10 (authentication processing unit 11) and the wireless terminal 30 when the authentication processing unit 11 executes the authentication processing. In the update processing, processing similar to the authentication processing described above is executed, and thus a new private key is generated in the authentication device 10 and the wireless terminal 30. That is, the update processing unit 12 includes a random number generation unit (not illustrated) that generates a random number for updating the private key, and a key generation unit (not illustrated) that generates a new private key after the update.

In the present embodiment, one or all of the authentication processing unit 11 and the update processing unit 12 are implemented by at least one processor (that is, a computer of the authentication device 10) included in the authentication device 10, which execute a predetermined program, that is, software. One or all of the authentication processing unit 11 and the update processing unit 12 may be implemented by hardware such as a predetermined processing circuit, or may be implemented by a combination of the software and hardware.

The communication unit 13 transmits a random number to the wireless terminal 30 when the authentication processing and update processing described above are executed. In the present embodiment, the communication unit 13 is implemented by a processor (a first processor), an antenna, a communication device, and the like included in the authentication device 10.

As described above, in a case where the network slices are constructed between the authentication device 10 and the wireless terminal 30, the private key is generated for each of the network slices, but the information holding unit 14 holds (stores) the private key generated for each of the network slices in association with an identifier (hereinafter, referred to as a network slice identifier) for identifying the network slice.

In the present embodiment, the information holding unit 14 is implemented by a memory (a first memory), a storage device, or the like included in the authentication device 10.

FIG. 4 is a block diagram illustrating an example of the configuration of the wireless terminal 30. As illustrated in FIG. 4, the wireless terminal 30 includes a communication unit 31, a key generation unit 32, and an information holding unit 33.

The communication unit 31 receives the random number transmitted from the authentication device 10 in a case where the authentication device 10 executes the authentication processing. In the similar manner, the communication unit 31 receives the random number transmitted from the authentication device 10 in a case where the authentication device 10 executes the update processing. When the authentication processing and update processing described above are executed, the communication unit 31 transmits the EAP response described in FIG. 2 to the authentication device 10.

In the present embodiment, the communication unit 31 is implemented by a processor (a second processor) an antenna, a communication device, and the like included in the wireless terminal 30.

The key generation unit 32 generates the private key used for wireless communication with the base station 20 based on the shared private key written in advance in the SIM card inserted into the wireless terminal 30 and the random number received by the communication unit 31.

In the present embodiment, one or all of the key generation unit 32 is implemented by at least one processor (that is, a computer of the wireless terminal 30) included in the wireless terminal 30, which execute a predetermined program, that is, software. One or all of the key generation unit 32 may be implemented by hardware such as a predetermined processing circuit, or may be implemented by a combination of the software and hardware.

As described above, the private key is generated for each of the network slices, but the information holding unit 33 holds (stores) the private key generated for each of the network slices by the key generation unit 32 in association with a network slice identifier for identifying the network slice.

In the present embodiment, the information holding unit 33 is implemented by a memory (a second memory), a storage device, or the like included in the wireless terminal 30.

FIG. 5 illustrates an example of a data structure of the information holding unit 14 included in the authentication device 10. As illustrated in FIG. 5, the information holding unit 14 holds information regarding a private key, an expiration date, an allowable latency time, and a maximum communication amount in association with the network slice identifier.

The network slice identifier is an identifier for identifying a network slice constructed between the authentication device 10 and the wireless terminal 30.

The private key is a private key (private key used in the network slice) used for wireless communication executed by using the network slice identified by the associated network slice identifier.

The expiration date is an expiration date set for the associated private key. The expiration date includes, for example, year, month, day, and time, but may be expressed in other formats.

The allowable latency time is a latency time allowed in wireless communication executed by using the network slice identified by the associated network slice identifier.

The maximum communication amount is a maximum communication amount (maximum value of a communicable data amount) in wireless communication executed by using the network slice identified by the associated network slice identifier.

In the example illustrated in FIG. 5, an example of the data structure of the information holding unit 14 in a case where the network slices including first and second network slices are constructed between the authentication device 10 and the wireless terminal 30 is illustrated.

Specifically, the information holding unit 14 holds a private key “Private key 1”, an expiration date “xxxx/xx/xx xx:xx”, an allowable latency time “50 ms”, and a maximum communication amount “Maximum communication amount 1” in association with a network slice identifier “001”. According to this, it is indicated that the private key used in the wireless communication using the network slice (first network slice) identified by the network slice identifier “001” is the “Private key 1”, and the expiration date of the “Private key 1” is “xxxx year xx month xx day xx time xx minute”. It is indicated that the allowable latency time in the wireless communication using the first network slice is “50 ms”, and the maximum communication amount in the wireless communication is “Maximum communication amount 1”.

Specifically, the information holding unit 14 holds a private key “Private key 2”, an expiration date “yyyy/yy/yy yy:yy”, an allowable latency time “1 s”, and a maximum communication amount “Maximum communication amount 2” in association with a network slice identifier “002”. According to this, it is indicated that the private key used in the wireless communication using the network slice (second network slice) identified by the network slice identifier “002” is the “Private key 2”, and the expiration date of the “Private key 2” is “yyyy year yy month yy day yy time yy minute”. It is indicated that the allowable latency time in the wireless communication using the second network slice is “1 s”, and the maximum communication amount in the wireless communication is “Maximum communication amount 2”.

The expiration date described above is set in advance for the private key when the private key is generated, for example, by executing the authentication processing and the update processing.

Since each of the network slices is operated independently as described above, the allowable latency time, maximum communication amount, and the like described above are different for each of the network slices. The first network slice described above is a network slice (allocated for image distribution) used for, for example, distributing an image since the allowable latency time is short. On the other hand, the second network slice is a network slice (allocated for file transmission) used for, for example, transmitting a file since the allowable latency time is long.

Here, only the information (that is, the information regarding the first and second network slices) held by the information holding unit 14 in association with the network slice identifier for identifying the first and second network slices has been described. However, in a case where a network slice is constructed other than the first and second network slices, the information regarding the network slice is also held in the information holding unit 14.

Here, it has been described that the information holding unit 14 holds (information of) the network slice identifier, the private key, the expiration date, the allowable latency time, and the maximum communication amount for each of the network slices. However, the information holding unit 14 may hold information other than these pieces of information, or may not hold a part of these pieces of information.

Here, the data structure of the information holding unit 14 included in the authentication device 10 has been described, but similar information is also held in the information holding unit 33 included in the wireless terminal 30. The information held in the information holding unit 14 included in the authentication device 10 and the information held in the information holding unit 33 included in the wireless terminal 30 may be the same or different.

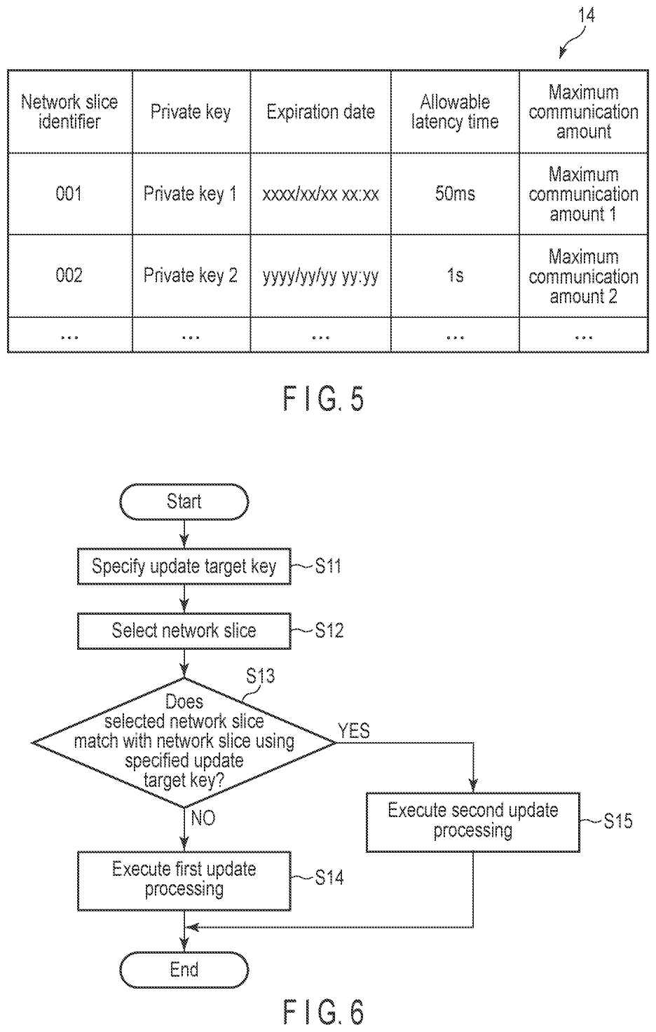

Next, an example of a processing procedure of the authentication device 10 when the private key is updated will be described with reference to a flowchart of FIG. 6. Here, the private key is already held in the authentication device 10 (information holding unit 14) and the wireless terminal 30 (information holding unit 33) by executing the authentication processing described above, and the wireless communication using the private key is executed between the base station 20 and the wireless terminal 30.

First, the update processing unit 12 included in the authentication device 10 refers to the information holding unit 14 and specifies a private key (hereinafter, referred to as an update target key) to be updated (Step S11).

The update target private key is specified based on the expiration date (expiration date set for the private key) held in the information holding unit 14 in association with the private key among a plurality of the private keys held in the information holding unit 14 (that is, the private keys used for wireless communication executed by using each of the network slices constructed between the authentication device 10 and the wireless terminal 30).

Specifically, for example, in a case where there is a corresponding expiration date within a predetermined period from the current date and time, the update processing unit 12 specifies the private key held in the information holding unit 14 in association with the expiration date as the update target private key.

Here, for example, in a case where the update target key specified in Step S11 is updated, it is necessary to transmit a random number for updating the update target key from the authentication device 10 to the wireless terminal 30, but it is conceivable to use a network slice using the update target key for the transmission of the random number.

However, for example, in a case where the first network slice in which the allowable latency time is 50 ms and the second network slice in which the allowable delay time is 1 s are constructed, and the private key (hereinafter, referred to as a first private key) used in the first network slice is specified as an update target key, when the update processing (that is, transmission of a random number or the like) of the first private key is executed by using the first network slice, there is a possibility that the wireless communication executed by using the first network slice is affected, and the latency time exceeding the allowable latency time occurs. In this case, it is preferable to update the first private key by using the second network slice different from the first network slice (that is, the second network slice in which the allowable latency time is longer than that in the first network slice).

In the present embodiment, with reference to the information holding unit 14, the update processing unit 12 selects a network slice to be used (that is, used to transmit the random number) when updating the update target key (Step S12).

In this case, the update processing unit 12 can select the network slice based on, for example, the allowable latency time held in the information holding unit 14. Specifically, in a case where the first network slice in which the allowable latency time is 50 ms and the second network slice in which the allowable latency time is 1 s are constructed, the update processing unit 12 selects the second network slice in which the allowable latency time is long (that is, the network slice identified by the network slice identifier held in the information holding unit 14 in association with the longest allowable latency time).

In Step S12, one network slice may be selected from the network slices constructed between the authentication device 10 and the wireless terminal 30, and the selected network slice may be a network slice in which the wireless communication using the update target key (network slice in which the update target key is used) is executed, or may be another network slice other than the network slice in which the update target is used.

Here, it has been described that the network slice is selected based on the allowable latency time held in the information holding unit 14, but the network slice may be selected based on, for example, the current communication amount (current data amount with which the wireless communication is executed) in the wireless communication executed by using each of the network slices. In this case, for example, the update processing unit 12 can measure the current communication amount (data amount) in the wireless communication executed by using each of the network slices, and select the network slice in which the measured current communication amount is the smallest.

The update processing unit 12 may select the network slice based on the maximum communication amount held in the information holding unit 14. In this case, the update processing unit 12 can select, for example, the network slice in which the communication amount is the largest (that is, the network slice identified by the network slice identifier held in the information holding unit 14 in association with the largest maximum communication amount).

The update processing unit 12 may select the network slice based on the current communication amount described above and the maximum communication amount held in the information holding unit 14. In this case, the update processing unit 12 can select the network slice in which a difference between the current communication amount and the maximum communication amount is the maximum or the network slice in which a ratio of the current communication amount to the maximum communication amount is the minimum. In other words, the update processing unit 12 may select the network slice having a margin for the current communication amount (that is, communication state) in the set communication band.

The selection processing of the network slice described here is an example, and the update processing unit 12 only needs to select the network slice in which the updating of the update target key is less likely to affect the wireless communication between the base station 20 and the wireless terminal 30. For example, the network slice may be selected in comprehensive consideration of the allowable latency time, the current communication amount, the maximum communication amount, and the like, which is described above.

Next, the update processing unit 12 determines whether or not the network slice selected in Step S12 (hereinafter, referred to as the selected network slice) matches with the network slice using the update target key specified in Step S11 (Step S13). The network slice corresponding to the update target key specified in Step S11 is a network slice identified by the network slice identifier held in the information holding unit 14 in association with the update target key.

In a case where it is determined that the selected network slice does not match with the network slice using the update target key (NO in Step S13), the update processing unit 12 executes first update processing (Step S14).

Hereinafter, the first update processing will be described. In the first update processing, the update processing unit 12 (communication unit 13) transmits a random number for updating the update target key to the wireless terminal 30 by using the selected network slice.

The random number transmitted from the update processing unit 12 (communication unit 13) to the wireless terminal 30 in this manner is received by the communication unit 31 included in the wireless terminal 30, and the key generation unit 32 included in the wireless terminal 30 generates a new private key (that is, the updated private key) based on the shared private key written in the SIM card inserted into the wireless terminal 30 and the random number received by the communication unit 31. The private key generated by the key generation unit 32 in this manner is held in the information holding unit 33 in association with the network slice identifier for identifying the network slice using the update target key, and is used for wireless communication between the base station 20 and the wireless terminal 30, the wireless communication being executed by using the network slice.

The update processing unit 12 included in the authentication device 10 generates a new private key (that is, the updated private key) based on the shared private key held in the communication carrier and the random number transmitted to the wireless terminal 30. The private key generated by the update processing unit 12 in this manner is held in the information holding unit 14 in association with the network slice identifier for identifying the network slice using the update target key, and is used for wireless communication between the base station 20 and the wireless terminal 30, the wireless communication being executed by using the network slice.

The first update processing described above assumes, for example, a case where the update target key specified in Step S11 is the first private key used in the first network slice, and the network slice selected in Step S12 (selected network slice) is the second network slice different from the first network slice. In this case, the update processing of the first private key is executed by using the second network slice at update timing of the first private key based on the expiration date set for the first private key.

Here, it has been described that the random number for updating the update target key is transmitted from the authentication device 10 to the wireless terminal 30, but the update processing unit 12 may further transmit information regarding use start timing (hereinafter, referred to as use start timing information) of the private key updated based on the random number to the wireless terminal 30. According to this, the base station 20 and the wireless terminal 30 can start to use the updated private key based on the use start timing (information).

The use start timing information includes, for example, a date and time (time information) when the use of the updated private key is started, and the date and time is calculated based on, for example, the expiration date set for the update target key (expiration date held in the information holding unit 14 in association with the update target key). The date and time included in the use start timing information may be a date and time before the expiration date set for the update target key.

For example, in a case where a sequence number of data is assigned to each data transmitted from the base station 20 to the wireless terminal 30, the use start timing information may include a sequence number of data for starting to use the updated private key instead of the date and time.

Here, it has been described that the use start timing information includes the date and time or the sequence number of the data, but when the base station 20 and the wireless terminal 30 can determine the use start timing of the updated private key, the use start timing information including information other than the date and time and the sequence number of the data may be used.

However, for example, in a case where it is set in advance that the use of the updated private key is started at a predetermined timing, the use start timing information described above may not be transmitted to the wireless terminal 30.

In a case where the authentication device 10 sets the expiration date of the updated private key, the expiration date may be transmitted from the authentication device 10 to the wireless terminal 30 in addition to the random number and use timing information described above.

Here, it is assumed that the first update processing described above updates the first private key by using the second network slice, but the private key used in the second network slice (hereinafter, referred to as the second private key) may be further updated in the first update processing. The updating of the second private key is performed by transmitting the random number for updating the second private key to the wireless terminal 30 by using the second network slice. However, in addition to the random number, the use start timing information or the like may be transmitted to the wireless terminal 30 in the similar manner to the updating of the first private key described above.

In a case where it is determined that the selected network slice matches with the network slice using the update target key (YES in Step S13), the update processing unit 12 executes second update processing (Step S15).

Here, in the second update processing, for example, it is assumed that the update target key specified in Step S11 is the second private key used in the second network slice, and the network slice selected in Step S12 is the second network slice (that is, the second private key is updated by using the second network slice). However, in the second update processing, the private key (for example, the first private key) different from the second private key can be updated in addition to the second private key. In this case, the update processing of the first private key is executed by using the second network slice at update timing of the second private key based on the expiration date set for the second private key.

The first update processing and the second update processing are different from each other in that in the first update processing, the first private key (and the second private key) is updated at the update timing of the first private key, and in the second update processing, the first private key (and the second private key) is updated at the update timing of the second private key. However, the detailed description of the second update processing will be omitted here since the first update processing and the second update processing are the same in the other aspects.

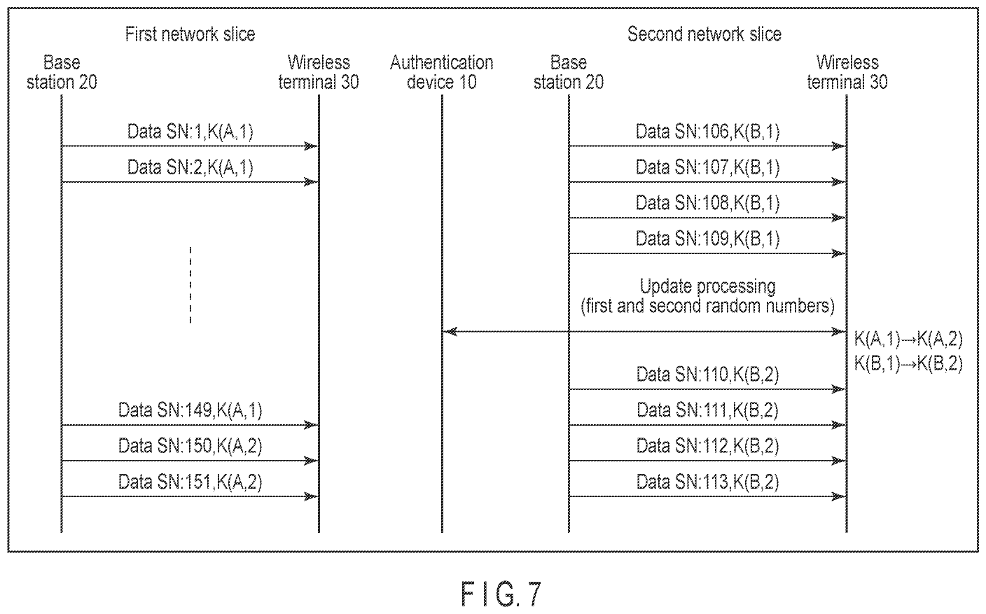

Here, a specific example of the update processing of the private key executed in the present embodiment will be described with reference to FIG. 7.

Here, the first and second network slices are constructed between the authentication device 10 (base station 20) and the wireless terminal 30, and the wireless terminal 30 executes wireless communication with the base station 20 by using each of the first network slice and the second network slice. In the example illustrated in FIG. 7, multiple data are transmitted from the base station 20 to the wireless terminal 30, and a sequence number SN is assigned to each of the data.

The data transmitted from the base station 20 to the wireless terminal 30 by using the first network slice is encrypted by using, for example, a public key corresponding to the first private key described above (hereinafter, referred to as a first public key), and the wireless terminal 30 decrypts the data by using the first private key K (A, 1) held in the information holding unit 33 included in the wireless terminal 30.

In the similar manner, the data transmitted from the base station 20 to the wireless terminal 30 by using the second network slice is encrypted by using, for example, a public key corresponding to the second private key described above (hereinafter, referred to as a second public key), and the wireless terminal 30 decrypts the data by using the second private key K (B, 1) held in the information holding unit 33 included in the wireless terminal 30.

Here, for example, the first private key K (A, 1) is specified (that is, the update timing of the first private key K (A, 1) is determined) as the update target key at timing after data with the sequence number SN of “109” is transmitted from the base station 20 to the wireless terminal 30 by using the second network slice and before data with the sequence number SN of “110” is transmitted from the base station 20 to the wireless terminal 30 by using the second network slice.

For example, when the allowable latency time of the first network slice is 50 ms and the allowable latency time of the second network slice is 1 s, the second network slice is selected as the network slice used for updating the first private key K (A, 1).

In this case, the update processing of the first private key K (A, 1) and the second private key (B, 1) is executed by using the second network slice. In the update processing, a random number for updating the first private key K (A, 1) (hereinafter, referred to as a first random number) and a random number for updating the second private key K (B, 1) (hereinafter, referred to as a second random number) are transmitted from the authentication device 10 to the wireless terminal 30, the first private key K (A, 1) is updated to a first private key K (A, 2) based on the first random number, and the second private key K (B, 1) is updated to a second private key K (B, 2) based on the second random number.

In a case where the first private key K (A, 1) is updated to the first private key K (A, 2), the first public key is also updated in the similar manner. In a case where the second private key K (B, 1) is updated to the second private key K (B, 2), the second public key is updated in the similar manner.

Here, it is assumed that the use start timing information regarding use start timing of the first private key K (A, 2) (that is, the updated first private key) is transmitted to the wireless terminal 30 by using the second network slice, and the use start timing information includes the sequence number SN. When the sequence number SN included in the use start timing information is “150”, as illustrated in FIG. 7, the use of the first private key K (A, 2) is started at timing when data with the sequence number SN of “150” is transmitted from the base station 20 to the wireless terminal 30. In this case, data encrypted by using the updated first public key is transmitted from the base station 20, and the wireless terminal 30 decrypts the data by using the updated first private key K (A, 2).

On the other hand, for example, the use of the second private key K (B, 2) is started immediately after the update processing of the second private key K (B, 1) is completed. However, similarly to the first private key K (A, 2), the use of the second private key K (B, 2) may be started based on the sequence number SN or the like (use start timing information).

The processing described here corresponds to the first update processing (processing in Step S14 illustrated in FIG. 6) executed when the first private key K (A, 1) is specified as the update target key. However, for example, in a case where the second private key K (B, 1) is specified as the update target key, the first private key K (A, 1) and the second private key K (B, 1) can be updated by executing the second update processing described above (processing in Step S15 illustrated in FIG. 6).

As described above, in the present embodiment, the authentication device 10 holds, for each of the network slices, the private key used for wireless communication executed by using each of the network slices constructed between the wireless terminal (wireless communication device) 30 and the authentication device 10, and transmits the first random number for updating the first private key used for wireless communication executed by using the first network slice included in the network slices and the use start timing information regarding use start timing of the updated first private key to the wireless terminal 30 by using the second network slice different from the first network slice. In this case, the first private key updated based on the first random number described above is held in the information holding unit 14 of the authentication device 10, and is used for wireless communication between the base station 20 and the wireless terminal 30, the wireless communication being executed by using the first network slice based on the use start timing transmitted to the wireless terminal 30.

In the present embodiment, the wireless terminal 30 holds, for each of the network slices, the private key used for wireless communication executed by using each of the network slices constructed between the wireless terminal 30 and the authentication device 10, and receives the first random number for updating the first private key used for wireless communication executed by using the first network slice included in the network slices and the use start timing information regarding use start timing of the updated first private key from the authentication device 10 by using the second network slice different from the first network slice. In this case, the first private key updated based on the first random number described above is held in the information holding unit 33 of the wireless terminal 30, and is used for wireless communication with the base station 20, the wireless communication being executed by using the first network slice based on the use start timing received from the authentication device 10.

In the present embodiment, with the configuration described above, it is possible to update the first private key used in the first network slice in a state in which the wireless communication is continued without affecting the wireless communication executed by using the first network slice (that is, without applying a communication load to the first network slice). In other words, for example, there are various techniques related to a method of connecting a plurality of network slices and a method of generating a private key. However, in the present embodiment, after the authentication processing of the authentication device 10 is executed, it is possible to implement appropriate operation of the private key in association with the network slices.

In the present embodiment, for example, the second network slice used when the first private key is updated is selected based on the latency time allowed in wireless communication executed by using each of the first and second network slices. According to this, for example, the first private key can be updated by using the second network slice in which the allowable latency time is long without decreasing a communication quality of the first network slice in which the allowable latency time is short.

In the present embodiment, the second network slice used when the first private key is updated may be selected based on the communication amount in wireless communication executed by using each of the first and second network slices. According to this, for example, the first private key can be updated by using the second network slice with a margin of communication state without decreasing a communication quality of the first network slice without the margin of the communication state.

In the present embodiment, when the first random number and the use start timing information are transmitted to the wireless terminal 30, the second random number for updating the second private key used for wireless communication executed by using the second network slice may be transmitted to the wireless terminal 30 by using the second network slice. In this case, the second private key updated based on the second random number is held in the information holding unit 14 of the authentication device 10, and is used for wireless communication between the base station 20 and the wireless terminal 30, the wireless communication being executed by using the second network slice. The second random number transmitted from the authentication device 10 is received by the wireless terminal 30, and the second private key updated based on the second random number is held in the information holding unit 33 of the wireless terminal 30 and used for wireless communication with the base station 20, the wireless communication being executed by using the second network slice.

In the present embodiment, with such a configuration, since the second private key can also be updated when the first private key is updated, the private key can be efficiently updated.

Here, it has been described that the first and second private keys are updated for convenience. However, in a case where three or more network slices including the first and second network slices are constructed, processing of updating three or more private keys including the first and second private keys may be executed by using one network slice.

The update processing of the first private key in the present embodiment may be executed based on, for example, update timing of the first private key determined based on the expiration date set for the first private key, or may be executed based on update timing of the second private key determined based on the expiration date set for the second private key.

In the present embodiment, the use start timing information described above may include a date and time calculated based on the expiration date set for the first private key, or may include a sequence number of data assigned to the data transmitted in wireless communication executed by using the first network slice (that is, the sequence number of the data for starting the use of the updated first private key). By transmitting the use start timing information from the authentication device 10 to the wireless terminal 30, use of the updated first private key can be started at desired timing.

(Second Embodiment)

Next, the second embodiment will be described. Configurations of a wireless communication system, an authentication device, and a wireless terminal according to the present embodiment are similar to those of the first embodiment described above, and thus will be appropriately described with reference to FIGS. 1, 3, 4, and the like.

Here, in the first embodiment described above, it has been described that the network slices including the first and second network slices are constructed in advance between the authentication device 10 (base station 20) and the wireless terminal 30. However, in the wireless communication system (5G mobile communication system), it is possible to construct a new network slice (hereinafter, referred to as a third network slice) by newly allocating resources.

In the first embodiment described above, it has been described that the update target key (for example, the first private key) is updated by using one (for example, the second network slice) of the network slices already constructed. However, the present embodiment is different from the first embodiment described above in that the update target key is updated by using the third network slice at timing when the third network slice described above is constructed.

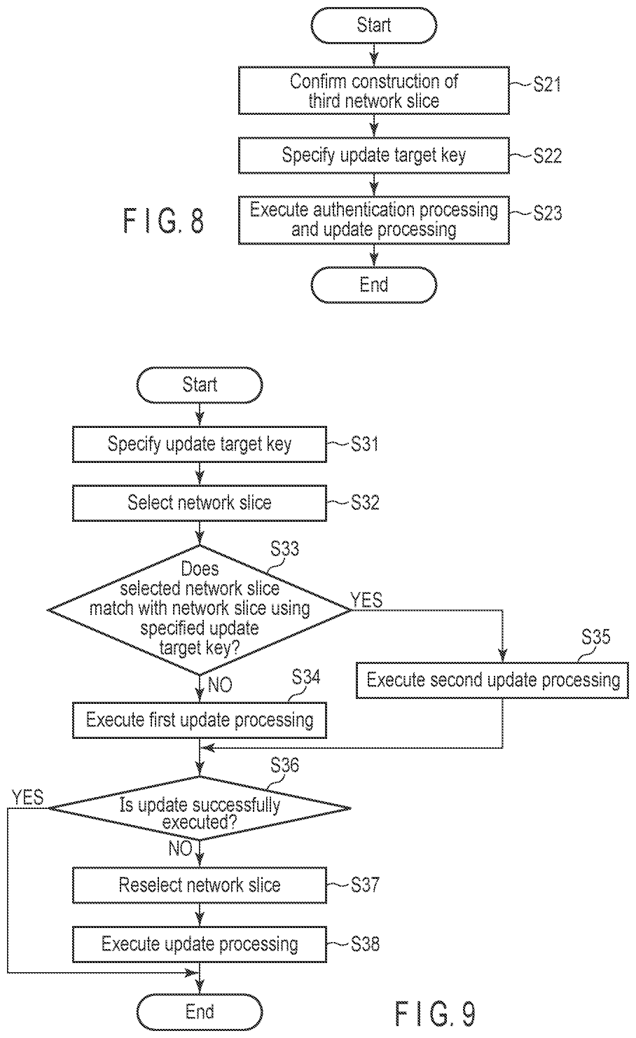

Hereinafter, an example of a processing procedure of the authentication device 10 when the private key is updated will be described with reference to a flowchart of FIG. 8. Here, the private key is already held in the authentication device 10 (information holding unit 14) and the wireless terminal 30 (information holding unit 33) by executing the authentication processing described in the first embodiment described above, and wireless communication using the private key is executed between the base station 20 and the wireless terminal 30.

Here, it is assumed that the third network slice is newly constructed as a new network slice different from the network slices including the first and second network slices already constructed between the authentication device 10 (base station 20) and the wireless terminal 30. In this case, the authentication device 10 is notified of information indicating the construction of the third network slice, and the authentication device 10 confirms the construction of the third network slice (that is, it is timing when the third network slice is newly constructed) (Step S21).

When the processing in Step S21 is executed, the update processing unit 12 included in the authentication device 10 specifies the update target key with reference to the information holding unit 14 (Step S22). In Step S22, the private key used in the network slice that is concerned to affect wireless communication by executing the update processing (that is, transmitting a random number for updating the private key) is specified as the update target key.

Specifically, in Step S22, for example, the private key used in the network slice in which the allowable latency time is short can be specified as the update target key based on the allowable latency time held in the information holding unit 14. In Step S22, for example, the current communication amount in wireless communication executed by using each of the network slices may be measured, and the private key used in the network slice in which the measured current communication amount is large is specified as the update target key. In Step S22, for example, the private key used in the network slice in which the maximum communication amount is small may be specified as the update target key based on the maximum communication amount held in the information holding unit 14. In Step S22, the private key used in the network slice in which a difference between the current communication amount and the maximum communication amount is small or in the network slice in which a ratio of the current communication amount to the maximum communication amount is great may be specified as the update target key.

When the processing of Step S22 is executed, the authentication processing unit 11 and the update processing unit 12 execute authentication processing and update processing using the third network slice (Step S23).

The detailed description of the authentication processing is omitted, but the private key (hereinafter, referred to as a third private key) is generated in the authentication device 10 and the wireless terminal 30 by executing the processing described in FIG. 2. Hereinafter, in the wireless communication between the base station 20 and the wireless terminal 30 using the third network slice, the third private key generated in this manner is used.

On the other hand, in the update processing, the random number for updating the update target key (for example, the first private key) specified in Step S22 is transmitted from the authentication device 10 to the wireless terminal 30, and the updated private key is generated based on the random number. Since the update processing executed in Step S23 is the same as that described in the first embodiment except that the third network slice (new network slice) is used for updating the update target key, the detailed description thereof will be omitted here.

As described above, in the present embodiment, in a case where the third network slice different from the network slices (first and second network slices) already constructed between the authentication device 10 (base station 20) and the wireless terminal 30 is newly constructed, the first private key is updated by transmitting the first random number and the use start timing information to the wireless terminal 30 by using the third network slice.

In the present embodiment, with the configuration described above, it is possible to update the first private key at timing when the third network slice is newly constructed without affecting the wireless communication executed by using the first network slice (that is, without applying a communication load).

In the first embodiment described above, for example, since the second network slice is used for updating the first private key, a communication load is not applied to the first network slice, but the communication load is applied to the second network slice. On the other hand, in the present embodiment, since the private key is updated by using the newly constructed third network slice (that is, the network slice in which the wireless communication between the base station 20 and the wireless terminal 30 is not started), there is an advantage that the communication load is not applied to the network slice in which the wireless communication is already started.

In the present embodiment, the first private key is updated at timing when a new third network slice is constructed. However, in a case where a new network slice is not constructed, the first private key (and the second private key) may be updated by executing the processing illustrated in FIG. 6.

In the present embodiment, the number of private keys (that is, the update target keys) updated by using the third network slice may be one or plural. Specifically, as described above, in the present embodiment, since the private key is updated by using the network slice in which the wireless communication (data communication) between the base station 20 and the wireless terminal 30 is not started (that is, wireless communication between the base station 20 and the wireless terminal 30 is not affected), the update target key may be a private key of all the network slices constructed between the authentication device 10 (and the base station 20) and the wireless terminal 30.

(Third Embodiment)

Next, the third embodiment will be described.

Configurations of a wireless communication system, an authentication device, and a wireless terminal according to the present embodiment are similar to those of the first embodiment described above, and thus will be appropriately described with reference to FIGS. 1, 3, 4, and the like.

Here, in the first embodiment described above, it has been described that the first private key is updated by using the second network slice, but depending on a communication state or the like related to wireless communication executed by using the second network slice, the update processing of the first private key using the second network slice may not succeed (fail). The present embodiment is different from the first embodiment described above in that, for example, in a case where the updating of the first private key does not succeed, another network slice different from the second network slice is reselected and the update processing of the first private key is executed.

Hereinafter, an example of a processing procedure of the authentication device 10 when the private key is updated will be described with reference to a flowchart of FIG. 9. Here, the private key is already held in the authentication device 10 (information holding unit 14) and the wireless terminal 30 (information holding unit 33) by executing the authentication processing described in the first embodiment described above, and wireless communication using the private key is executed between the base station 20 and the wireless terminal 30.

First, processing of Steps S31 to S35 corresponding to Steps S11 to S15 illustrated in FIG. 6 are executed.

Next, the update processing unit 12 included in the authentication device 10 determines whether or not the private key (the first and second private keys) has been successfully updated as a result of execution of the processing in Step S34 or S35 (Step S36). In the update processing of the private key, processing similar to the authentication processing illustrated in FIG. 2 is executed. However, in Step S36, in a case where the sequence of the processing illustrated in FIG. 2 has not reached the end, it is determined that the private key is not successfully updated (that is, the updating of the private key has failed). Specifically, in the update processing, for example, in a case where the EAP response cannot be normally received from the wireless terminal 30, it is determined that the update target key is not successfully updated.

In a case where it is determined that the private key is not successfully updated in Step S36 (NO in Step S36), the update processing unit 12 reselects a network slice other than the network slice selected in Step S32 (Step S37).

For example, when the second network slice is selected in Step S32, one network slice is selected among the network slices other than the second network slice (that is, the network slice in which the updating of the update target key has failed) in Step S37.

When the processing of Step S37 is executed, the update processing unit 12 executes the update processing of the private key by using the network slice reselected in Step S37 (Step S38). Since the update processing of the private key has been described in the first embodiment, the detailed description thereof will be omitted here.

In a case where the update processing of the first and second private keys is executed in the first or second update processing executed in Step S34 or Step S35, the update processing of the first and second private keys only needs to be executed by using the network slice reselected in Step S37. However, in Step S38, the private key used in the reselected network slice may be further updated.

Although not illustrated in FIG. 9, in a case where the private key is not successfully updated even when the processing of Step S38 is executed, the processing may return to Step S37 and may be repeated.

On the other hand, in a case where it is determined that the private key has been successfully updated in Step S36, the processing illustrated in FIG. 9 is ended.

As described above, in the present embodiment, for example, in a case where the first private key (and the second private key) is not successfully updated, the first random number and the use start timing information are transmitted to the wireless terminal 30 by using the network slice (third network slice) different from the network slice (second network slice) used for the update.

In the present embodiment, with the configuration described above, it is possible to update the first private key used in the third network slice without affecting the wireless communication executed by using the first network slice (that is, without applying a communication load) even in a case where the updating of the first private key using the second network slice has failed.

According to at least one of the embodiments described above, it is possible to provide the authentication device, the wireless communication device, the wireless communication system, the method, and the program, in which the network slices can be appropriately operated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An authentication device comprising:
a memory configured to store, for each of a plurality of network slices, a private key used for wireless communication executed by using each of the network slices constructed between a wireless communication device and the authentication device; and
a processor configured to:
transmit a first random number for updating a first private key used for the wireless communication executed by using a first network slice included in the network slices and use start timing information regarding use start timing of the updated first private key to the wireless communication device by using a second network slice different from the first network slice,
wherein the first private key updated based on the first random number is stored in the memory, and used for the wireless communication between a base station and the wireless communication device based on the use start timing, the wireless communication being executed by using the first network slice.

2. The authentication device according to claim 1, wherein when the first random number and the use start timing information are transmitted to the wireless communication device, the processor is configured to further transmit a second random number for updating a second private key used for the wireless communication executed by using the second network slice to the wireless communication device by using the second network slice, and
the second private key updated based on the second random number is stored in the memory and used for the wireless communication between the base station and the wireless communication device, the wireless communication being executed by using the second network slice.

3. The authentication device according to claim 1, wherein the processor is configured to transmit the first random number and the use start timing information based on update timing of the first private key based on an expiration date set for the first private key.

4. The authentication device according to claim 1, wherein the processor is configured to transmit the first random number and the use start timing information based on update timing of the second private key based on an expiration date set for the second private key used for the wireless communication executed by using the second network slice.

5. The authentication device according to claim 1, wherein the second network slice used for transmitting the first random number and the use start timing information is selected based on a latency time allowed in the wireless communication executed by using each of the first and second network slices.

6. The authentication device according to claim 1, wherein the second network slice used for transmitting the first random number and the use start timing information is selected based on a communication amount or a maximum communication amount in the wireless communication executed by using each of the first and second network slices.

7. The authentication device according to claim 1, wherein the use start timing information includes a date and time calculated based on the expiration date set for the first private key.

8. The authentication device according to claim 1, wherein a sequence number of data is assigned to each data transmitted in the wireless communication executed by using the first network slice, and the use start timing information includes a sequence number of data for starting use of the updated first private key.

9. The authentication device according to claim 1, wherein in a case where a third network slice different from the network slices is newly constructed, the processor is configured to transmit the first random number and the use start timing information to the wireless communication device by using the third network slice instead of the second network slice.

10. The authentication device according to claim 1, wherein in a case where the first private key is not successfully updated, the processor is configured to transmit the first random number and the use start timing information to the wireless communication device by using a third network slice different from the second network slice.

11. A wireless communication device comprising:
a memory configured to store, for each of a plurality of network slices, a private key used for wireless communication executed by using each of the network slices constructed between an authentication device and the wireless communication device; and
a processor configured to receive a first random number for updating a first private key used for the wireless communication executed by using a first network slice included in the network slices and use start timing information regarding use start timing of the updated first private key from the authentication device by using a second network slice different from the first network slice,
wherein the first private key updated based on the first random number is stored in the memory, and used for the wireless communication with a base station based on the use start timing, the wireless communication being executed by using the first network slice.

12. The wireless communication device according to claim 11, wherein when the first random number and the use start timing information are received from the authentication device, the processor is configured to further receive a second random number for updating a second private key used for the wireless communication executed by using the second network slice from the authentication device by using the second network slice, and
the second private key updated based on the second random number is stored in the memory and used for the wireless communication with the base station, the wireless communication being executed by using the second network slice.

13. A wireless communication system in which a plurality of network slices are constructed between an authentication device and a wireless communication device,
wherein the authentication device includes
a first memory configured to store, for each of the network slices, a private key used for wireless communication executed by using each of the network slices, and
a first processor configured to transmit a first random number for updating a first private key used for the wireless communication executed by using a first network slice included in the network slices and use start timing information regarding use start timing of the updated first private key to the wireless communication device by using a second network slice different from the first network slice,
the wireless communication device includes
a second memory configured to store, for each of the network slices, the private key used for the wireless communication executed by using each of the network slices, and
a second processor configured to receive the first random number and the use start timing information, and
the first private key updated based on the first random number is stored in the first memory and the second memory, and used for the wireless communication between a base station and the wireless communication device based on the use start timing, the wireless communication being executed by using the first network slice.

14. A method executed by an authentication device comprising:
storing, for each of a plurality of network slices, a private key used for wireless communication executed by using each of the network slices constructed between a wireless communication device and the authentication device in a memory; and
transmitting a first random number for updating a first private key used for the wireless communication executed by using a first network slice included in the network slices and use start timing information regarding use start timing of the updated first private key to the wireless communication device by using a second network slice different from the first network slice,
wherein the first private key updated based on the first random number is stored in the memory, and used for the wireless communication between a base station and the wireless communication device based on the use start timing, the wireless communication being executed by using the first network slice.

15. A method executed by a wireless communication device comprising:
storing, for each of a plurality of network slices, a private key used for wireless communication executed by using each of the network slices constructed between an authentication device and the wireless communication device in a memory; and
receiving a first random number for updating a first private key used for the wireless communication executed by using a first network slice included in the network slices and use start timing information regarding use start timing of the updated first private key from the authentication device by using a second network slice different from the first network slice,
wherein the first private key updated based on the first random number is stored in the memory, and used for the wireless communication with a base station based on the use start timing, the wireless communication being executed by using the first network slice.

16. A non-transitory computer-readable storage medium having stored thereon a program executed by a computer of an authentication device, the program comprising instructions capable of causing the computer to execute functions of:
storing, for each of a plurality of network slices, a private key used for wireless communication executed by using each of the network slices constructed between a wireless communication device and the authentication device in a memory; and
transmitting a first random number for updating a first private key used for the wireless communication executed by using a first network slice included in the network slices and use start timing information regarding use start timing of the updated first private key to the wireless communication device by using a second network slice different from the first network slice,
wherein the first private key updated based on the first random number is stored in the memory, and used for the wireless communication between a base station and the wireless communication device based on the use start timing, the wireless communication being executed by using the first network slice.

17. A non-transitory computer-readable storage medium having stored thereon a program executed by a computer of a wireless communication device, the program comprising instructions capable of causing the computer to execute functions of:
storing, for each of a plurality of network slices, a private key used for wireless communication executed by using each of the network slices constructed between an authentication device and the wireless communication device in a holding unit; and
receiving a first random number for updating a first private key used for the wireless communication executed by using a first network slice included in the network slices and use start timing information regarding use start timing of the updated first private key from the authentication device by using a second network slice different from the first network slice,
wherein the first private key updated based on the first random number is stored in the memory, and used for the wireless communication with a base station based on the use start timing, the wireless communication being executed by using the first network slice.
